(19) United States
(12) Patent Application Publication
(10) Pub. No.: US 2024/0395464 A1
(43) Pub. Date: Nov. 28, 2024

(54) MULTILAYER CERAMIC CAPACITOR

(71) Applicant: Murata Manufacturing Co., Ltd., Nagaokakyo-shi (JP)

(72) Inventor: Ryo NISHIMURA, Nagaokakyo-shi (JP)

(21) Appl. No.: 18/791,646

(22) Filed: Aug. 1, 2024

Related U.S. Application Data
(63) Continuation of application No. PCT/JP2023/030833, filed on Aug. 27, 2023.

(30) Foreign Application Priority Data
Oct. 4, 2022 (JP) 2022-160614

(51) Int. Cl. H01G 4/30; H01G 2/06; H01G 4/008; H01G 4/012

(52) U.S. Cl. CPC H01G 4/30; H01G 2/065; H01G 4/008; H01G 4/012

(57) ABSTRACT

A multilayer ceramic capacitor includes first and second internal electrodes, first and second main surfaces opposed to each other, first and second end surface opposed to each other, and first and second lateral surfaces opposed to each other, and first and second external electrodes on an outer surface of the ceramic element body. Each of the first internal electrodes is electrically connected with the first external electrode. Each of the second internal electrodes is electrically connected with the second external electrode. When a cross section is viewed, the first external electrode has an L-shape on the first end surface and the first main surface, and the second external electrode has an L-shape on the second end surface and the first main surface.

### CROSS REFERENCE TO RELATED APPLICATIONS

This application claims the benefit of priority to Japanese Patent Application No. 2022-160614, filed on Oct. 4, 2022, and is a Continuation Application of PCT Application No. PCT/JP2023/030833, filed on Aug. 27, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors are widely used in electronic devices and various devices including electronic appliances (hereinafter referred to as “electronic devices, etc.”). For example, Unexamined Japanese Patent Application Publication No. 2000-100647 discloses a multilayer ceramic capacitor having a typical structure.

Recently, reductions in size and increased functionality of such electronic devices, etc., have been rapidly progressing. The reduction in size of such electronic devices, etc., has resulted in an extremely small internal volume (space volume) of such electronic devices, etc., which house electronic circuits composed of electronic components. In addition, the number of electronic components necessary for configuring an electronic circuit has rapidly increased due to the increased functionality of such electronic devices, etc.

Therefore, as such electronic devices, etc., are reduced in size and more sophisticated, electronic components constituting the electronic circuit are also required to be reduced in size. For example, regarding multilayer ceramic capacitors, extremely thin products in each of which a ceramic element body has a thickness of several tens of μm have been put into practical use.

As described above, with the reduction in size and increased functionality of electronic devices, etc., a reduction in size, thinning of electronic components is particularly required. However, thinning of multilayer ceramic capacitors may cause a decrease in mechanical strength against an external force.

On the other hand, such multilayer ceramic capacitors are often mounted on a substrate or its equivalent (hereinafter, both are collectively referred to as “substrate”) by a reflow soldering process described below.

First, a substrate to be mounted is prepared. An electrode is provided on the main surface of the substrate, and a cream solder is applied to the surface of the electrode in advance. Next, a mounter device having a nozzle is prepared. Then, after the top surface (the second main surface) of a multilayer ceramic capacitor is suctioned by the nozzle, the nozzle is moved to place the bottom surface (the first main surface) of the multilayer ceramic capacitor on the pair of electrodes coated with the cream solder of the substrate. Next, the substrate on which the multilayer ceramic capacitor is provided is heated to melt the cream solder, and then the entire product is cooled to solidify the cream solder again, thereby mounting the multilayer ceramic capacitor on the electrode of the substrate.

In the reflow soldering process, when the multilayer ceramic capacitor is placed on the electrode of the substrate by the nozzle, a ridge line, which is an outer edge of the bottom surface (the first main surface) of the ceramic element body, collides with the substrate or the electrode provided on the substrate, and a crack or the like (hereinafter, “crack”, “fracture”, “defect”, and the like are generically referred to as “cracks, etc.”) occurs in the ceramic element body. In particular, in multilayer ceramic capacitors each having a reduced thickness and a reduced mechanical strength against an external force, cracks, etc. in such a ceramic element body occurring at the time of mounting or the like may adversely affect the multilayer ceramic capacitor.

### SUMMARY OF THE INVENTION

Example embodiments of the present invention provide multilayer ceramic capacitors that are each able to reduce or prevent an occurrence of cracks, etc., in a ceramic element body even when a ridge line, which is an outer edge of a bottom surface (a first main surface) of the ceramic element body, collides with a substrate, an electrode provided on the substrate, etc., for example, at the time of mounting.

An example embodiment of the present invention provides a multilayer ceramic capacitor including a ceramic element body including ceramic layers, first internal electrodes and second internal electrodes laminated in a height direction, a first main surface and a second main surface opposed to each other in the height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction, and a first external electrode and a second external electrode on an outer surface of the ceramic element body, in which each of the first internal electrodes extends toward and is exposed at the first end surface, and is electrically connected with the first external electrode, each of the second internal electrodes extends toward and is exposed at the second end surface, and is electrically connected with the second external electrode. When a cross section parallel or substantially parallel to the first lateral surface and the second lateral surface is viewed, the first external electrode has an L-shape on the first end surface and the first main surface, and the second external electrode has an L-shape on the second end surface and the first main surface. R dimensions of a ridge line where the first main surface and the first end surface are in contact with each other, a ridge line where the first main surface and the first lateral surface are in contact with each other, a ridge line where the first main surface and the second end surface are in contact with each other, and a ridge line where the first main surface and the second lateral surface are in contact with each other are respectively larger than R dimensions of a ridge line where the second main surface and the first end surface are in contact with each other, a ridge line where the second main surface and the first lateral surface are in contact with each other, a ridge line where the second main surface and the second end surface are in contact with each other, and a ridge line where the second main surface and the second lateral surface are in contact with each other.

In the multilayer ceramic capacitors according to example embodiments of the present invention, since the R dimensions of the ridge line where the first main surface (the bottom surface, the mounting surface) is in contact with the first end surface, the ridge line where the first main surface is in contact with the first lateral surface, the ridge line where the first main surface is in contact with the second end surface, and the ridge line where the first main surface is in contact with the second lateral surface are large. Therefore, even if these ridge lines collide with the substrate or the electrode provided on the substrate, etc., at the time of mounting, cracks, etc., are less likely to occur in the ceramic element body.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor 100 according to a first example embodiment of the present invention, and shows the multilayer ceramic capacitor 100 viewed from a first main surface 1A.

FIG. 2 is a perspective view of the multilayer ceramic capacitor 100, and shows the multilayer ceramic capacitor 100 viewed from a second main surface 1B.

FIG. 3 is a cross-sectional view of the multilayer ceramic capacitor 100, and shows a cross section taken along the line X-X indicated by an alternate long and short dash line arrow in FIG. 1A.

FIG. 4 is a cross-sectional view of a main portion of the multilayer ceramic capacitor 100.

FIGS. 5A to 5D are explanatory views showing steps in an example of a method of manufacturing the multilayer ceramic capacitor 100.

FIGS. 6E to 6J are continuations of FIG. 5D, and are explanatory views showing steps in an example of a method of manufacturing the multilayer ceramic capacitor 100.

FIG. 7 is a cross-sectional view of a multilayer ceramic capacitor 200 according to a second example embodiment of the present invention.

FIGS. 8A to 8D are explanatory views showing steps in an example of a method of manufacturing the multilayer ceramic capacitor 200.

FIGS. 9E to 9J are continuations of FIG. 8D, and are explanatory views showing steps in an example of the method of manufacturing the multilayer ceramic capacitor 200.

### DETAILED DESCRIPTION OF THE EXAMPLE EMBODIMENTS

Hereinafter, example embodiments of the present invention will be described with reference to the drawings.

Each example embodiment exemplifies an example embodiment of the present invention, and the present invention is not limited to the contents of the example embodiments. Further, it is possible to implement the present invention by combining the contents described in different example embodiments, and such implementations are also encompassed in the present invention. In addition, the drawings are to aid in understanding of the specification and may be schematically drawn, and the drawn components or the ratio of the dimensions between the components may not coincide with the ratio of the dimensions described in the specification. In addition, components described in the specification may be omitted in the drawings or may be drawn with the number of components omitted.

### First Example Embodiment

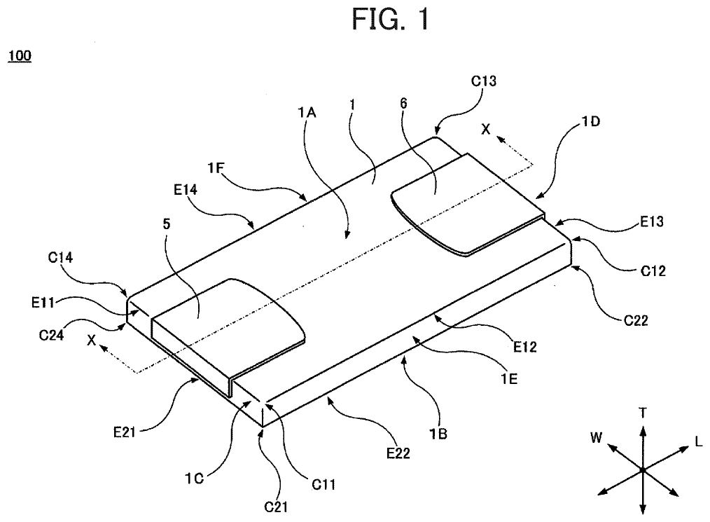

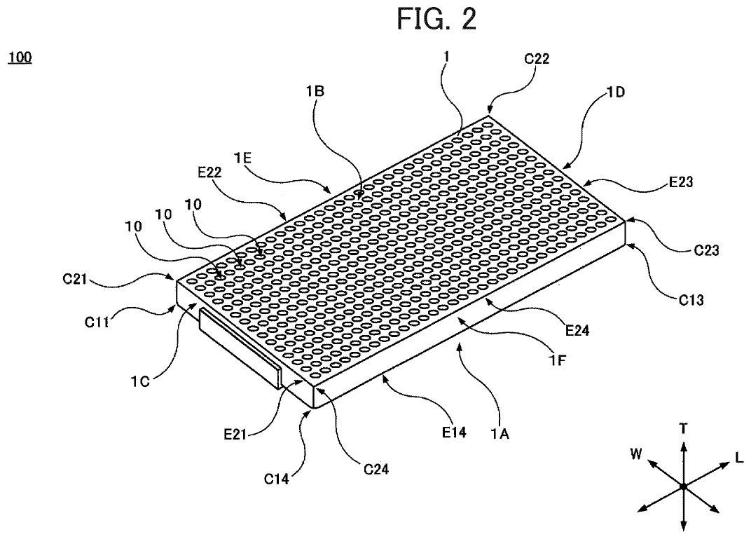

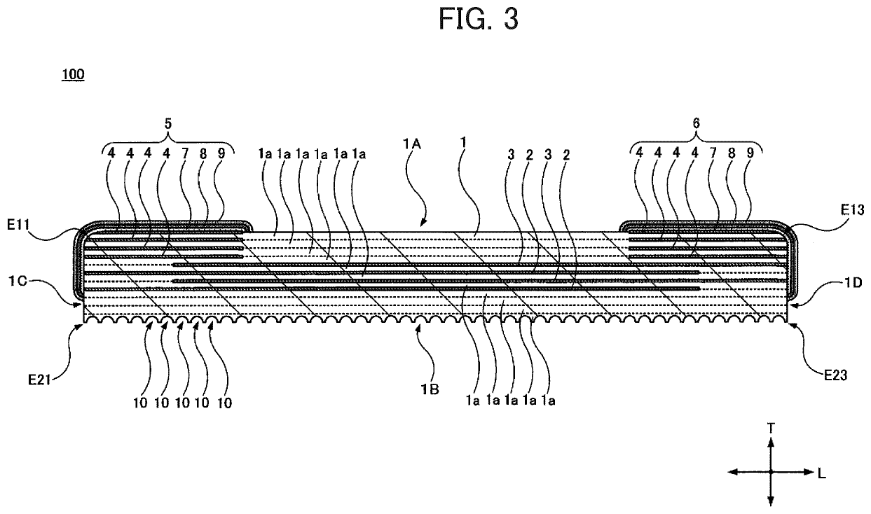

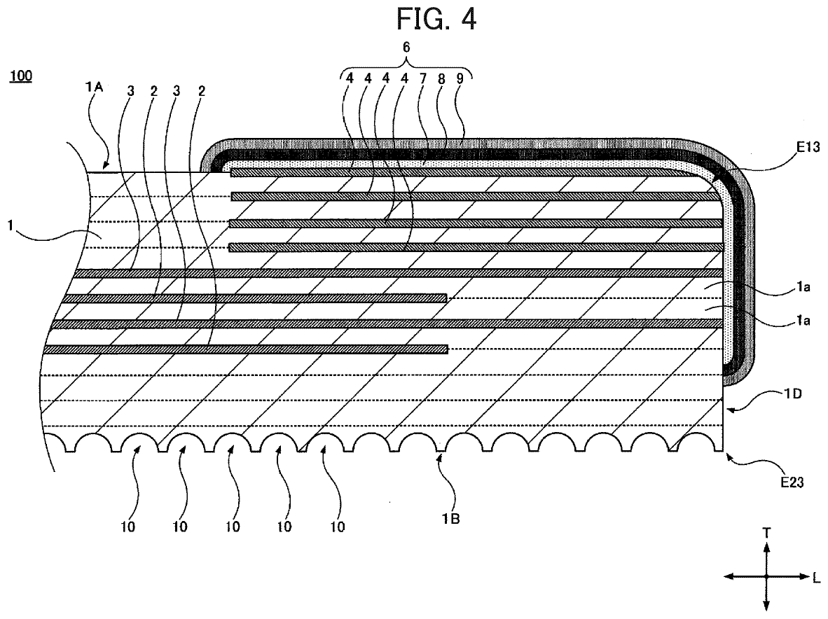

Each of FIGS. 1, 2, 3, and 4 shows a multilayer ceramic capacitor 100 according to a first example embodiment of the present invention. FIG. 1 is a perspective view of the multilayer ceramic capacitor 100, and shows the multilayer ceramic capacitor 100 viewed from the first main surface 1A. FIG. 2 is also a perspective view of the multilayer ceramic capacitor 100, and shows the multilayer ceramic capacitor 100 viewed from the second main surface 1B. FIG. 3 is a cross-sectional view of the multilayer ceramic capacitor 100, and shows a cross section taken along the line X-X indicated by an alternate long and short dash line arrow in FIG. 1A. FIG. 4 is a cross-sectional view of a main portion of the multilayer ceramic capacitor 100.

In the drawings, a height direction T, a length direction L, and a width direction W of the multilayer ceramic capacitor 100 are shown, and these directions may be referred to in the following description. In the present example embodiment, the stacking (e.g., lamination) direction of ceramic layers 1a described later is defined as the height direction T of the multilayer ceramic capacitor 100.

The multilayer ceramic capacitor 100 includes a ceramic element body 1. The ceramic element body 1 preferably has a rectangular or substantially rectangular parallelepiped shape, and includes a first main surface 1A and a second main surface 1B opposed to each other in the height direction T, a first end surface 1C and a second end surface 1D opposed to each other in the length direction L, and a first lateral surface 1E and a second lateral surface 1F opposed to each other in the width direction W.

The specific dimensions of the ceramic element body 1 could be any desirable dimensions, but it is preferable that one of the dimension in the length direction L or the dimension in the width direction W is about 1.0 mm or less and the other is about 0.5 mm or less, for example. It is also preferable that the dimension in the height direction T is about 0.1 mm or less, for example. When the present invention is implemented, also in the multilayer ceramic capacitor 100 having a reduced size and thinner layers, the R dimension (e.g., ridge dimension) of each of the ridge lines where the first main surface 1A, which is a mounting surface, is in contact with and the first end surface 1C, the first lateral surface 1E, the second end surface 1D, and the second lateral surface 1F is large as will be described later. Therefore, even if these ridge lines, e.g., the first main surface of the ceramic element body, collides with the substrate or the electrode, etc., provided on the substrate at the time of mounting, the occurrence of cracks, etc., in the ceramic element body 1 is reduced or prevented.

The ceramic element body 1 includes a stack or lamination of ceramic layers 1a, first internal electrodes 2, second internal electrodes 3, and dummy internal electrodes 4. The ceramic layers 1a, the first internal electrodes 2, the second internal electrodes 3, and the dummy internal electrodes 4 are stacked or laminated in the height direction T of the ceramic element body 1.

As will be described later, each of the dummy internal electrodes 4 mainly defines and functions as a base external electrode for each of a first external electrode 5 and a second externa electrode 6, rather than generating a capacitance.

The material of the ceramic element body 1 (the ceramic layers 1a) can be any desirable material but, for example, a dielectric ceramic including BaTiO₃ as a main component can be used. However, instead of BaTiO₃, dielectric ceramics mainly including other materials such as, for example, CaTio₃, SrTiO₃, and CaZro₃ may be used.

The thickness of each of the ceramic layers 1a is arbitrary, but may be, for example, about 0.3 μm to about 2.0 μm in the effective region of the capacitance formation in which the first internal electrodes 2 and the second internal electrodes 3 are provided.

The number of layers of the ceramic layers 1a is not specifically limited, but may be, for example, from 1 layer to 6000 layers in the effective region of capacitance formation in which the first internal electrodes 2 and the second internal electrodes 3 are provided.

The first internal electrode 2 and the second internal electrode 3 are not provided on both upper and lower sides of the ceramic element body 1. A protective layer (e.g., an outer layer) including only the ceramic layers 1a is provided on each of the upper and lower sides of the ceramic element body 1. However, in the present example embodiment, the dummy internal electrodes 4 are provided in the protective layers. The thickness of each of the protective layers may be any desirable thickness, but may be, for example, about 5 μm to about 150 μm. The thickness of each of the ceramic layers 1a of the protective layer may be larger than the thickness of each of the ceramic layers 1a in the effective region of the capacitance formation in which the first internal electrodes 2 and the second internal electrodes 3 are provided. The material of the ceramic layers 1a of the protective layer may be different from the material of the ceramic layers 1a in the effective region.

As is evident from FIG. 3, each of the first internal electrodes 2 extends in the length direction L of the ceramic element body 1, and includes one end portion which is exposed at the first end surface 1C of the ceramic element body 1. Each of the second internal electrodes 3 extends in the length direction L of the ceramic element body 1, and includes one end portion which is exposed at the second end surface 1D of the ceramic element body 1. The first internal electrodes 2 and the second internal electrodes 3 are preferably alternately laminated.

The dummy internal electrodes 4 each defining and functioning as the base external electrode for each of the first external electrode 5 and the second external electrode 6 are smaller in dimension in the length direction L than the first internal electrodes 2 and the second internal electrodes 3. The dummy internal electrodes 4 each include one end portion which extends toward and is exposed at either the first end surface 1C or the second end surface 1D of the ceramic element body 1. Further, one of the dummy internal electrodes 4 provided closest to the first main surface 1A of the ceramic element body 1 is exposed at the first main surface 1A of the ceramic element body 1.

In addition, in each of the first external electrode 5 and the second external electrode 6, one of the dummy internal electrodes 4 may be provided closest to the first main surface 1A of the ceramic element body 1 and may be exposed at the first main surface of the ceramic element body 1.

The materials of each of the main components (metal components) of the first internal electrodes 2, the second internal electrodes 3, and the dummy internal electrodes 4 are arbitrary, but, for example, Ni is used in the present example embodiment. However, other metals such as, for example, Cu, Ag, Pd, and Au may be used instead of Ni. Further, for example, Ni, Cu, Ag, Pd, Au, and the like may be alloys with other metals. The first internal electrodes 2, the second internal electrodes 3, and the dummy internal electrodes 4 may include other components such as ceramics in addition to the metal components.

The thickness of each of the first internal electrodes 2, the second internal electrodes 3, and the dummy internal electrodes 4 is arbitrary, but may be, for example, about 0.3 μm to about 1.5 μm.

The first external electrode 5 and the second external electrode 6 are provided on the outer surface of the ceramic element body 1. When a cross section parallel or substantially parallel to the first lateral surface 1E and the second lateral surface 1F is viewed, the first external electrode 5 has an L-shape on the first end surface 1C and the first main surface 1A, and the second external electrode 6 has an L-shape on the second end surface 1D and the first main surface 1A. The first external electrode 5 is electrically connected to the first internal electrodes 2 at the first end surface 1C. The second external electrode 6 is electrically connected to the second internal electrodes 3 at the second end surface 1D.

The first external electrode 5 and the second external electrode 6 include the same or substantially the same multilayer structure. In the present example embodiment, the first external electrode 5 and the second external electrode 6 each preferably include, for example, in order from the bottom, a base external electrode, a Cu-plated external electrode layer 7 provided outside the base external electrode, a Ni-plated external electrode layer 8 provided outside the Cu-plated external electrode layer 7, and an Au-plated external electrode layer 9 provided outside the Ni-plated external electrode layer 8. However, the structures and materials of the first external electrode 5 and the second external electrode 6 are arbitrary, and are not limited to these structures and materials. In addition, dimensions such as the thickness, width, and length of the first external electrode 5 and the second external electrode 6 are also arbitrary, and may be freely set. In particular, several variations of the number, material, and dimensions of the plated external electrode layers may be employed.

Next, the base external electrode of each of the first external electrode 5 and the second external electrode 6 will be described. The base external electrode refers to an electrode defining and functioning as a base when a plated external electrode layer is provided on the outside thereof.

The base external electrode of the first external electrode 5 includes the end portions of the first internal electrodes 2 and the dummy internal electrodes 4 respectively extending toward and exposed at the first end surface 1C, and a main surface of a corresponding one of the dummy internal electrodes 4 exposed at the first main surface 1A. FIG. 3 exemplifies a structure in which the first external electrode 5 includes four layers of dummy internal electrodes 4 each functioning as the base external electrode, an upper main surface of a corresponding one of the dummy internal electrodes 4 provided closest to the first main surface 1A is exposed at the first main surface 1A, and the end portions of the remaining three layers of dummy internal electrodes 4 extend toward and are exposed at the first end surface 1C. However, the number of layers of the dummy internal electrodes 4 of the first external electrode 5 is arbitrary. The first external electrode 5 may include at least one layer which is provided closest to the first main surface 1A of the ceramic element body 1, and an upper main surface of the one layer may be exposed outside from the first main surface 1A of the ceramic element body 1.

Similarly, the base external electrode of the second external electrode 6 includes the end portions of the second internal electrodes 3 and the dummy internal electrodes 4 respectively extending toward and exposed at the second end surface 1D, and a main surface of a corresponding one of the dummy internal electrodes 4 exposed at the first main surface 1A. FIGS. 3 and 4 exemplify a structure in which the second external electrode 6 includes four layers of dummy internal electrodes 4 each functioning as the base external electrode, an upper main surface of a corresponding one of the dummy internal electrodes 4 provided closest to the first main surface 1A is exposed at the first main surface 1A, and the end portions of the remaining three layers of dummy internal electrodes 4 extend toward and are exposed at the second end surface 1D. However, the number of layers of the dummy internal electrodes 4 of the second external electrode 6 is arbitrary. The second external electrode 6 may include at least one layer which is provided closest to the first main surface 1A of the ceramic element body 1, and an upper main surface of the one layer may be exposed outside from the first main surface 1A of the ceramic element body 1.

As described above, each of the end portions of the first internal electrodes 2 extending toward and exposed at the first end surface 1C of the ceramic element body 1 is a portion of the base external electrode of the first external electrode 5, and each of the end portions of the second internal electrodes 3 extending toward and exposed at the second end surface 1D of the ceramic element body 1 is a portion of the base external electrode of the second external electrode 6. For the purpose of avoiding complication of the drawings, in FIGS. 3 and 4, the end portions of the first internal electrodes 2 are not shown as a portion of the first external electrode 5 and the end portions of the second internal electrodes 3 are not shown as a portion of the second external electrode 6 (extension lines from reference numeral “5” in the diagram showing the first external electrode 5 and reference numeral “6” in the diagram showing the second external electrode 6 are omitted).

The base external electrode of each of the first external electrode 5 and the second external electrode 6 defines and functions as a base for forming the Cu-plated external electrode layer 7 on the outside thereof. As described above, in the present example embodiment, the end portions of the first internal electrodes 2 extending toward and exposed at the first end surface 1C, the end portions of the dummy internal electrodes 4, the end portions of the second internal electrode 3 extending toward and exposed at the second end surface 1D, and the end portions of the dummy internal electrodes 4 are also portions of the base external electrodes of the first external electrode 5 or the second external electrode 6. The end portions of the plurality of first internal electrodes 2 and the end portions of the plurality of dummy internal electrodes 4 extending linearly in the width direction W are exposed at the first end surface 1C. The end portions of the plurality of second internal electrodes 3 and the end portions of the plurality of dummy internal electrodes 4 extending linearly in the width direction W are exposed at the second end surface 1D. These end portions are exposed at intervals with an end portion of a corresponding one of the ceramic layers 1a extending linearly in the width direction W interposed therebetween. Even if the end portions of the first internal electrodes 2, the end portions of the second internal electrodes 3 and the end portions of the dummy internal electrodes 4 are provided at intervals, they define and function as bases when a plated external electrode layer is formed.

Each of the first external electrode 5 and the second external electrode 6 preferably includes, for example, a Cu-plated external electrode layer 7 outside the base external electrode. The Cu-plated external electrode layer 7 mainly defines and functions to improve moisture resistance. It is also preferable that the Cu-plated external electrode layer 7 includes Ni, for example. In this case, dissolution of the external electrode layer into the solder can be reduced or prevented.

Each of the first external electrode 5 and the second external electrode 6 preferably includes, for example, a Ni-plated electrode layer 8 outside the Cu-plated external external electrode layer 7. The Ni-plated external electrode layer 8 mainly defines and functions to improve solder heat resistance and bonding properties. It is also preferable that the Ni-plated external electrode layer 8 includes P, for example. In this case, the mechanical strength of the external electrode layer can be improved.

Each of the first external electrode 5 and the second external electrode 6 preferably includes, for example, the Au-plated external electrode layer 9 outside the Ni-plated external electrode layer 8. The Au-plated external electrode layer 9 mainly defines and functions to improve wettability of the external electrode layer to solder.

As can be seen from FIGS. 1 and 2, in the multilayer ceramic capacitor 100 of the present example embodiment, R dimensions of a ridge line E11 in which the first main surface 1A and the first end surface 1C are in contact with each other, a ridge line E12 in which the first main surface 1A and the first lateral surface 1E are in contact with each other, a ridge line E13 in which the first main surface 1A and the second end surface 1D are in contact with each other, and a ridge line E14 where the first main surface 1A and the second lateral surface 1F are in contact with each other are respectively larger than R dimensions of a ridge line E21 in which the second main surface 1B and the first end surface 1C are in contact with each other, a ridge line E22 in which the second main surface 1B and the first lateral surface 1E are in contact with each other, and a ridge line E23 in which the second main surface 1B and the second end surface 1D are in contact with each other, and a ridge line E24 where the second main surface 1B and the second lateral surface 1F are in contact with each other.

In the present example embodiment, a step of increasing the R dimension is separately provided in the manufacturing process for the ridge line E11 where the first main surface 1A and the first end surface 1C are in contact with each other, the ridge line E12 where the first main surface 1A and the first lateral surface 1E are in contact with each other, the ridge line E13 where the first main surface 1A and the second end surface 1D are in contact with each other, and the ridge line E14 where the first main surface 1A and the second lateral surface 1F are in contact with each other. On the other hand, the step of increasing the R dimension is not provided in the manufacturing process for the ridge line E21 where the second main surface 1B and the first end surface 1C are in contact with each other, the ridge line E22 where the second main surface 1B and the first lateral surface 1E are in contact with each other, the ridge line E23 where the second main surface 1B and the second end surface 1D are in contact with each other, and the ridge line E24 where the second main surface 1B and the second lateral surface 1F are in contact with each other.

In the multilayer ceramic capacitor 100, the first main surface 1A of the ceramic element body 1 including the first external electrode 5 and the second external electrode 6 is a mounting surface for a substrate (as described above, the substrate encompasses its equivalent). In the multilayer ceramic capacitor 100, the R dimension of each of the ridge line E11 in which the first main surface 1A and the first end surface 1C are in contact with each other, the ridge line E12 in which the first main surface 1A and the first lateral surface 1E are in contact with each other, the ridge line E13 in which the first main surface 1A and the second end surface 1D are in contact with each other, and the ridge line E14 in which the first main surface 1A and the second lateral surface 1F are in contact with each other, which are provided on the mounting surface, is large (because its roundness is large). Therefore, when the multilayer ceramic capacitor 100 is provided (placed) on the substrate, etc., for mounting, even when these ridge lines collide with the substrate or the electrode provided on the substrate, etc., the impact is mitigated, such that the occurrence of cracks, etc., in the ceramic element body 1 is reduced or prevented.

In addition, the R dimension of each of the ridge line E11 where the first main surface 1A and the first end surface 1C are in contact with each other, the ridge line E12 where the first main surface 1A and the first lateral surface 1E are in contact with each other, the ridge line E13 where the first main surface 1A and the second end surface 1D are in contact with each other, and the ridge line E14 where the first main surface 1A and the second lateral surface 1F are in contact with each other is preferably, for example, about 1 μm or more and about 10 μm or less. This is because, when the R dimension is less than about 1 μm, the advantageous effect of reducing or preventing the occurrence of cracks, etc., in the ceramic element body 1 is small. On the other hand, when the R dimension exceeds about 10 μm, it takes time to increase each R dimension of these ridge lines, and the productivity of the multilayer ceramic capacitor decreases. On the other hand, the R dimension of each of the ridge line E21 where the second main surface 1B and the first end surface 1C are in contact with each other, the ridge line E22 where the second main surface 1B and the first lateral surface 1E are in contact with each other, the ridge line E23 where the second main surface 1B and the second end surface 1D are in contact with each other, and the ridge line E24 where the second main surface 1B and the second lateral surface 1F are in contact with each other is preferably less than about 1 μm, for example. This is because, in this case, it is not necessary to separately provide a step of increasing each R dimension of these ridge lines.

Further, as can be appreciated from FIGS. 1 and 2, in the multilayer ceramic capacitor 100 of the present example embodiment, the R dimensions of a corner C11 at which the first main surface 1A, the first end surface 1C, and the first lateral surface 1E are in contact with each other, a corner C12 at which the first main surface 1A, the first lateral surface 1E, and the second end surface 1D are in contact with each other, a corner C13 at which the first main surface 1A, the second end surface 1D, and the second lateral surface 1F are in contact with each other, and a corner C14 at which the first main surface 1A, the second lateral surface 1F, and the first end surface 1C are in contact with each other are respectively larger than the R dimensions of a corner C21 where the second main surface 1B, the first end surface 1C, and the first lateral surface 1E are in contact with each other, a corner C22 where the second main surface 1B, the first lateral surface 1E, and the second end surface 1D are in contact with each other, a corner C23 where the second main surface 1B, the second end surface 1D, and the second lateral surface 1F are in contact with each other, and a corner C24 where the second main surface 1B, the second lateral surface 1F, and the first end surface 1C are in contact with each other. This is because the R dimensions of the ridge line E11 where the first main surface 1A and the first end surface 1C are in contact with each other, the ridge line E12 where the first main surface 1A and the first lateral surface 1E are in contact with each other, the ridge line E13 where the first main surface 1A and the second end surface 1D are in contact with each other, and the ridge line E14 where the first main surface 1A and the second lateral surface 1F are in contact with each other are respectively larger than the ridge line E21 where the second main surface 1B and the first end surface 1C are in contact with each other, the ridge line E22 where the second main surface 1B and the first lateral surface 1E are in contact with each other, the ridge line E23 where the second main surface 1B and the second end surface 1D are in contact with each other, and the ridge line E24 where the second main surface 1B and the second lateral surface 1F are in contact with each other. That is, the corner at which the two ridge lines each having a large R dimension intersect with each other has a larger R dimension than the corner at which the two ridge lines each having a small R dimension intersect with each other.

In the multilayer ceramic capacitor 100, the R dimensions of the corner C11 at which the first main surface 1A, the first end surface 1C, and the first lateral surface 1E are in contact with each other, the corner C12 at which the first main surface 1A, the first lateral surface 1E, and the second end surface 1D are in contact with each other, the corner C13 at which the first main surface 1A, the second end surface 1D, and the second lateral surface 1F are in contact with each other, and the corner C14 at which the first main surface 1A, the second lateral surface 1F, and the first end surface 1C are in contact with each other, which are provided on the mounting surface, are large. Therefore, when the multilayer ceramic capacitor 100 is placed on the substrate, etc., for mounting, even when the ceramic element body 1 collides with the substrate or the electrode formed on the substrate, the impact is mitigated, such that the occurrence of cracks, etc., in the ceramic element body 1 is reduced or prevented.

In the multilayer ceramic capacitor 100 of the present example embodiment, a plurality of embossed holes 10 are provided in the second main surface 1B of the ceramic element body 1. In the present example embodiment, a plurality of embossed holes 10 having the same or substantially the same shape and the same or substantially the same dimension are provided in the second main surface 1B of the ceramic element body 1 and aligned in the length direction L and the width direction W.

In the present example embodiment, an embossed hole refers to a recessed hole preferably having a bottom, for example. The recessed hole may be hemispherical or non-hemispherical. The dimensions, the number, the arrangement, the intervals, the regions to be provided, and the like of the embossed holes 10 can be appropriately set to any desirable arrangement. Any method may be applied for the method of forming the embossed holes 10. Whether or not the embossed holes 10 are provided in the second main surface 1B can be easily checked by comparing with other surfaces (for example, the first main surface 1A) of the ceramic element body 1.

In the multilayer ceramic capacitor 100, the second main surface 1B of the ceramic element body 1 refers to a surface to be suctioned by, for example, a nozzle of a mounter device at the time of mounting, and is a surface to which an impact may be applied by the nozzle. In the multilayer ceramic capacitor 100 of the present example embodiment, the plurality of embossed holes 10 are provided in the second main surface 1B of the ceramic element body 1. Therefore, even when an impact is applied by the nozzle or the like, the multilayer ceramic capacitor is resistant to the impact, and occurrence of cracks, etc., in the ceramic element body 1 is reduced or prevented. In addition, the impact resistance of the ceramic element body 1 can be improved favorably if the embossed holes 10 are fine enough to fit into the ceramic layer 1a having a depth of about one to several ten layers. However, when the depth of each of the embossed holes 10 becomes too large, the strength of the entire ceramic element body 1 may be reduced. Therefore, the depth of each of the embossed holes 10 does not need to be too large.

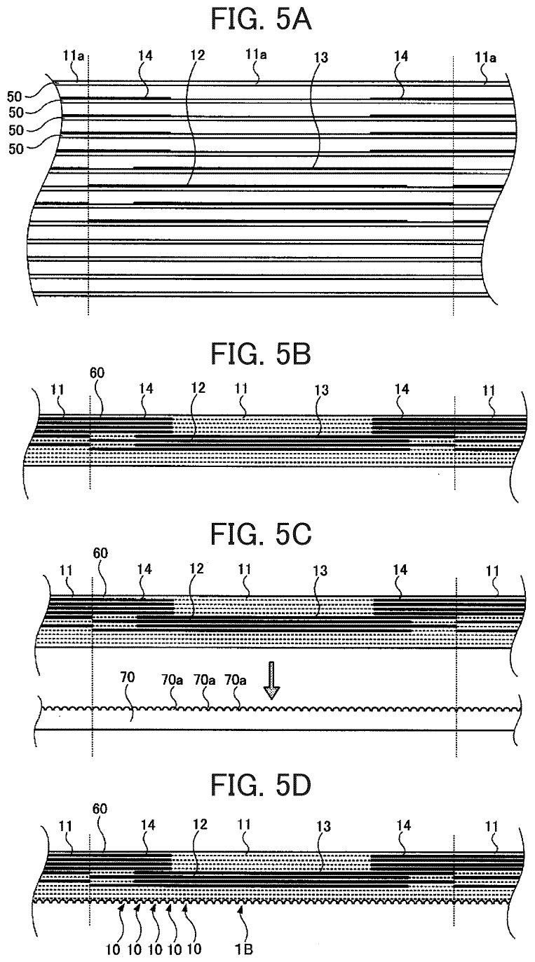

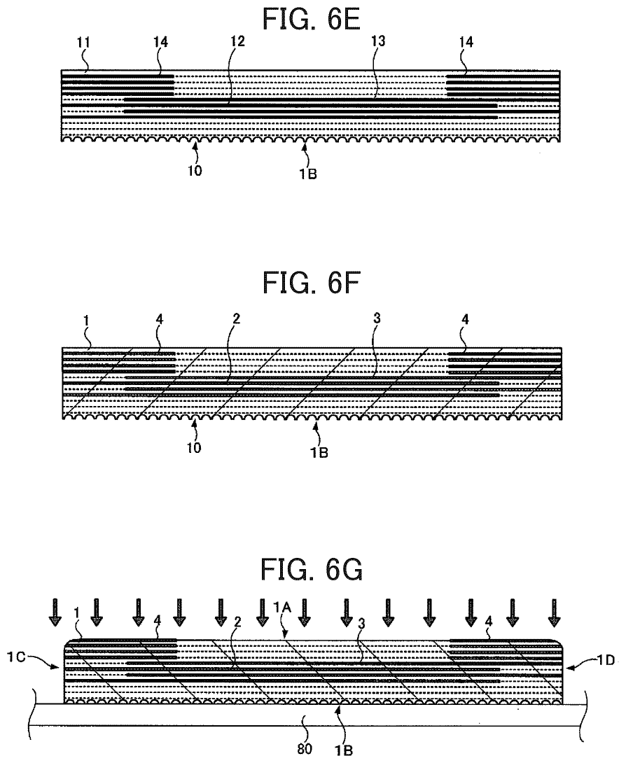

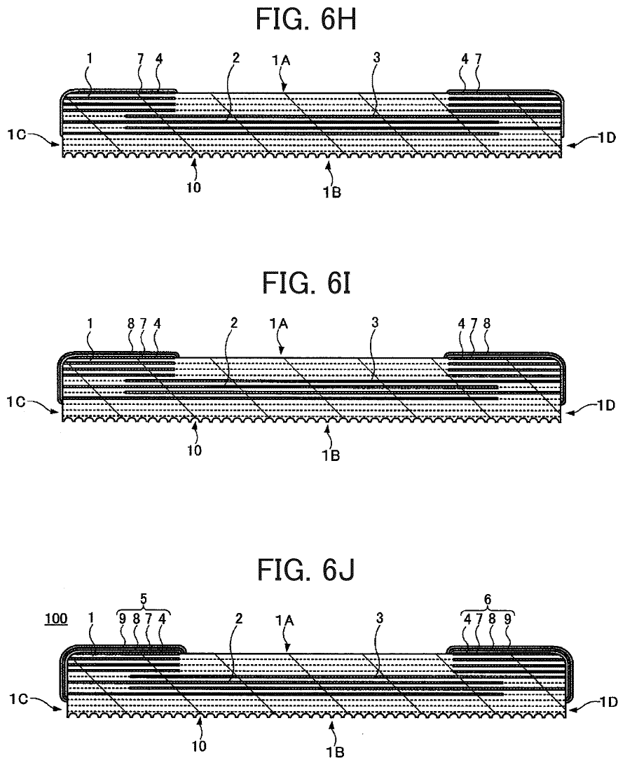

The multilayer ceramic capacitor 100 of the present example embodiment can be manufactured, for example, by the method shown in FIGS. 5A to 6J.

First, ceramic green sheets 11a for producing the ceramic layer 1a of the ceramic element body 1 shown in FIG. 5A are prepared. The ceramic green sheets 11a are prepared as mother ceramic green sheets 50 in which a large number of ceramic green sheets 11a are arranged in a matrix in order to collectively manufacture a large number of multilayer ceramic capacitors 100.

Although illustration is omitted, first, a dielectric ceramic powder, a binder resin, a solvent, and the like are prepared, and then these are wet-mixed to prepare a ceramic slurry.

Next, the ceramic slurry is applied onto the carrier film in a sheet shape using, for example, a die coater, a gravure coater, a microgravure coater, or the like, and dried to produce the mother ceramic green sheets 50.

Next, as shown in FIG. 5A, an electrically conductive paste 12 for forming the first internal electrodes 2, an electrically conductive paste 13 for forming the second internal electrodes 3, and an electrically conductive paste 14 for forming the dummy internal electrodes 4, which are prepared in advance, are applied (for example, printed) to the main surface of predetermined ceramic green sheets 11a of the mother ceramic green sheet 50 in a desired pattern shape. As the electrically conductive paste, for example, the mixture of a solvent, a binder resin, a metal powder (for example, Ni powder), and the like can be used.

Next, as shown in FIG. 5B, the mother ceramic green sheets 50 are laminated in a predetermined order and pressure-bonded to produce a mother unfired ceramic element body 60 in which a large number of unfired ceramic element bodies 11 are arranged in a matrix.

Next, as shown in FIG. 5C, a jig 70 in which a plurality of protruding portions 70a are provided on the upper main surface is prepared. Subsequently, the lower main surface of the mother unfired ceramic element body 60 is pressed against the plurality of protruding portions 70a of the jig 70. As a result, as shown in FIG. 4D, the plurality of embossed holes 10 are formed in the second main surface 1B of each unfired ceramic element body 11 of the mother unfired ceramic element body 60.

Next, as shown in FIG. 6E, the mother unfired ceramic element body 60 is cut into individual unfired ceramic element bodies 11.

Next, the unfired ceramic element body 11 is fired with a predetermined profile to produce the ceramic element body 1 shown in FIG. 6F. At this time, inside the ceramic element body 1, the electrically conductive paste 12 is simultaneously fired to form the first internal electrodes 2, the electrically conductive paste 13 is simultaneously fired to form the second internal electrodes 3, and the electrically conductive paste 14 is simultaneously fired to form the dummy internal electrodes 4.

Next, as illustrated in FIG. 6G, a jig 80 is prepared. Then, the second main surface 1B of the ceramic element body 1 is fixed to the upper main surface of the jig 80. Subsequently, for example, sandblasting is performed to cut down the first main surface 1A of the ceramic element body 1, and the main surface on the upper side of the dummy internal electrode 4 provided closest to the first main surface 1A of the ceramic element body 1 is exposed at the first main surface 1A of the ceramic element body 1.

At this time, the ridge line E11 where the first main surface 1A and the first end surface 1C are in contact with each other, the ridge line E12 where the first main surface 1A and the first lateral surface 1E are in contact with each other, the ridge line E13 where the first main surface 1A and the second end surface 1D are in contact with each other, and the ridge line E14 where the first main surface 1A and the second lateral surface 1F are in contact with each other are simultaneously cut down, such that the R dimensions of the ridge line E11 where the first main surface 1A and the first end surface 1C are in contact with each other, the ridge line E12 where the first main surface 1A and the first lateral surface 1E are in contact with each other, and the ridge line E13 where the first main surface 1A and the second end surface 1D are in contact with each other, and the ridge line E14 in which the first main surface 1A and the second lateral surface 1F are in contact with each other are respectively larger than the R dimensions of the ridge line E21 in which the second main surface 1B and the first end surface 1C are in contact with each other, the ridge line E22 in which the second main surface 1B and the first lateral surface 1E are in contact with each other, the ridge line E23 in which the second main surface 1B and the second end surface 1D are in contact with each other, and the ridge line E24 in which the second main surface 1B and the second lateral surface 1F are in contact with each other (the roundness becomes larger).

Next, as shown in FIG. 6H, the end portions of the first internal electrodes 2, the second internal electrodes 3, and the dummy internal electrodes 4 extending toward and exposed at the first end surface 1C and the second end surface 1D, and the upper main surfaces of corresponding ones of the dummy internal electrodes 4 exposed at the first main surface 1A are used as base external electrodes, and electroless plating is performed on the surfaces of these base external electrodes after applying a predetermined catalyst as necessary to form the Cu-plated external electrode layers 7.

Next, as shown in FIG. 6I, a predetermined catalyst is applied to the outside of the Cu-plated external electrode layer 7 as necessary, and then electroless plating is performed to form the Ni-plated external electrode layers 8.

Next, as shown in FIG. 6J, a predetermined catalyst is applied to the outside of the Ni-plated external electrode layer 8 as necessary, and then electroless plating is performed to form the Au-plated external electrode layers 9. As described above, the first external electrode 5 is formed in the L-shape on the first end surface 1C and the first main surface 1A of the ceramic element body 1, and the second external electrode 6 is formed in the L-shape on the second end surface 1D and the first main surface 1A of the ceramic element body 1, such that the multilayer ceramic capacitor 100 according to the first example embodiment is completed.

### Second Example Embodiment

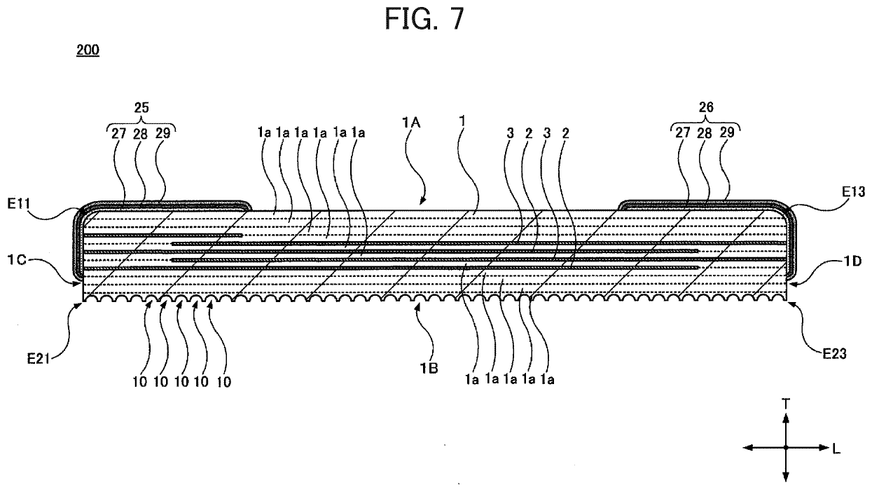

FIG. 7 shows a multilayer ceramic capacitor 200 according to a second example embodiment of the present invention. FIG. 7 is a cross-sectional view of the multilayer ceramic capacitor 200.

In the multilayer ceramic capacitor 200 according to the second example embodiment, a portion of the configuration of the multilayer ceramic capacitor 100 according to the first example embodiment described above is modified.

Specifically, in the multilayer ceramic capacitor 100, the dummy internal electrodes 4 are used as a portion of the base external electrode of each of the first external electrode 5 and the second external electrode 6. In the multilayer ceramic capacitor 200, the dummy internal electrodes 4 are omitted. In the multilayer ceramic capacitor 200, for example, a NiCr thin film layer 27 is provided by sputtering as a base external electrode of each of the first external electrode 25 and the second external electrode 26. The NiCr thin film layer 27 has high adhesion to the ceramic element body 1, and functions as an excellent base external electrode of each of the first external electrode 25 and the second external electrode 26.

In addition, in the multilayer ceramic capacitor 100, as the plated external electrode layers of each of the first external electrode 5 and the second external electrode 6, for example, the Cu-plated external electrode layer 7, the Ni-plated external electrode layer 8, and the Au-plated external electrode layer 9 are sequentially provided outside the base external electrode. In the multilayer ceramic capacitor 200, as the plated external electrode layers of the first external electrode 25 and the second external electrode 26, for example, the Ni-plated external electrode layer 28 and the Au-plated external electrode layer 29 are sequentially provided outside the NiCr thin film layer 27, which is the base external electrode.

The other configurations of the multilayer ceramic capacitor 200 are preferably the same or substantially the same as materials of the multilayer ceramic capacitor 100.

Similarly to the multilayer ceramic capacitor 100, in the multilayer ceramic capacitor 200, the R dimensions of the ridge line E11 in which the first main surface 1A and the first end surface 1C are in contact with each other, the ridge line E12 in which the first main surface 1A and the first lateral surface 1E are in contact with each other, the ridge line E13 in which the first main surface 1A and the second end surface 1D are in contact with each other, and the ridge line E14 in which the first main surface 1A and the second lateral surface 1F are in contact with each other are respectively larger than the R dimensions of the ridge line E21 in which the second main surface 1B and the first end surface 1C are in contact with each other, the ridge line E22 in which the second main surface 1B and the first lateral surface 1E are in contact with each other, the ridge line E23 in which the second main surface 1B and the second end surface 1D are in contact with each other, and the ridge line E24 where the second main surface 1B and the second lateral surface 1F are in contact with each other. Therefore, when the multilayer ceramic capacitor 200 is placed on a substrate, etc., for mounting, even if these ridge lines collide with the substrate or an electrode provided on the substrate, the impact is mitigated, such that the occurrence of cracks, etc., in the ceramic element body 1 is reduced or prevented.

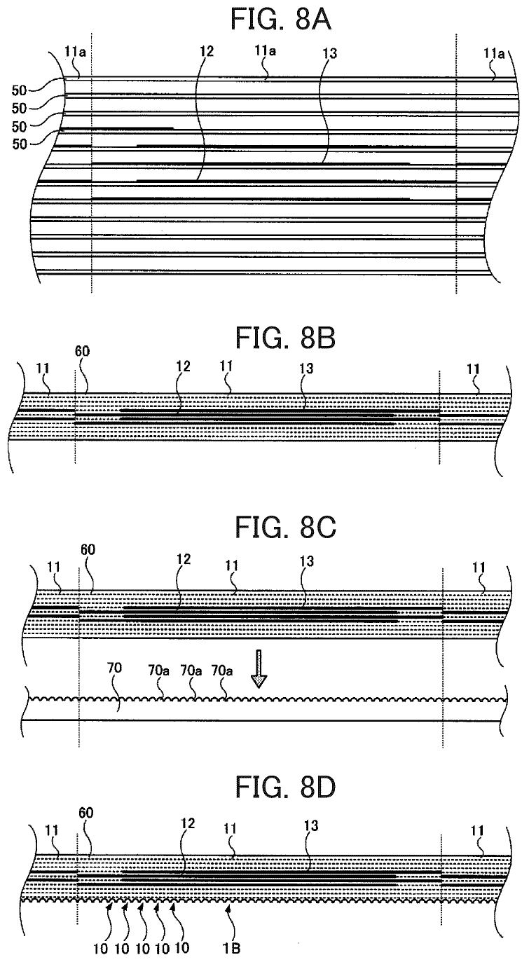

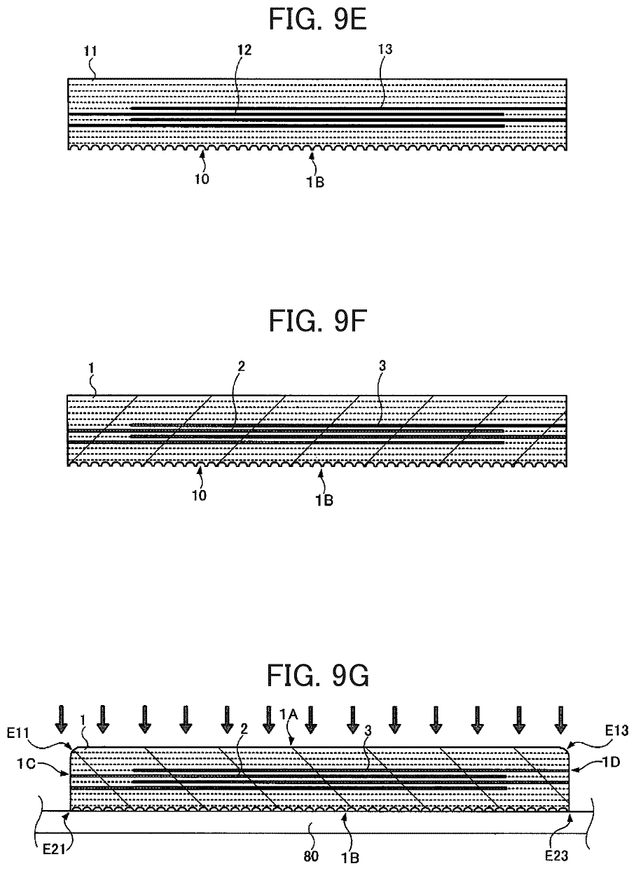

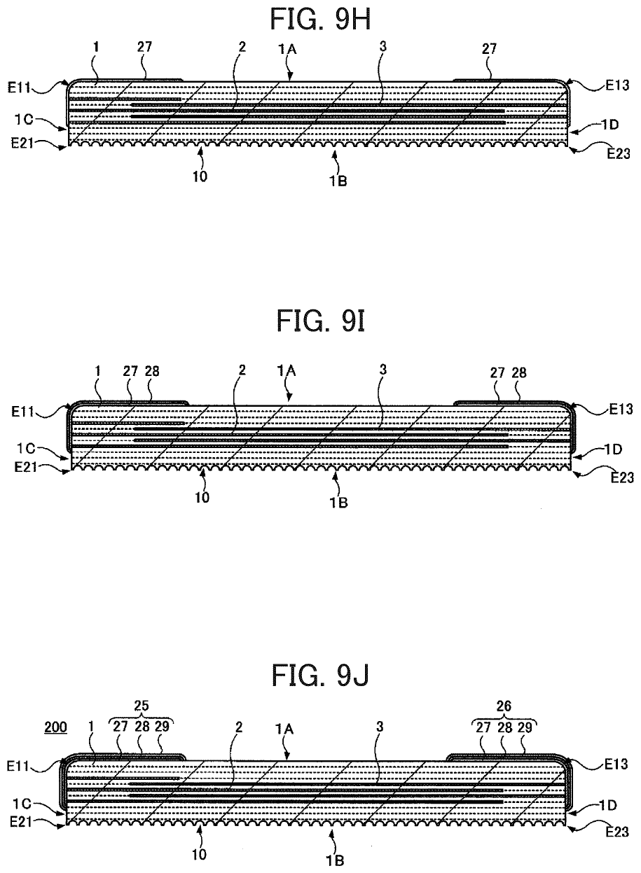

The multilayer ceramic capacitor 200 of the present example embodiment can be manufactured, for example, by the method shown in FIGS. 8A to 9J.

First, ceramic green sheets 11a for producing the ceramic layer 1a of the ceramic element body 1 shown in FIG. 8A is prepared. The ceramic green sheets 11a are prepared as mother ceramic green sheets 50 in order to collectively manufacture a large number of multilayer ceramic capacitors 100.

Next, as shown in FIG. 8A, an electrically conductive paste 12 for forming the first internal electrodes 2 and an electrically conductive paste 13 for forming the second internal electrodes 3, which are prepared in advance, are applied to the main surface of the predetermined ceramic green sheet 11a in the mother ceramic green sheet 50 in a desired pattern shape. Since the multilayer ceramic capacitor 200 does not include the dummy internal electrodes, the electrically conductive paste for forming the dummy internal electrodes is not applied.

Next, as shown in FIG. 8B, the mother ceramic green sheets 50 are laminated in a predetermined order, and pressure-bonded to manufacture a mother unfired ceramic element body 60.

Next, as shown in FIG. 8C, the lower main surface of the mother unfired ceramic element body 60 is pressed against a jig 70 in which a plurality of protruding portions 70a are provided on the upper main surface, whereby a plurality of embossed holes 10 are formed in the second main surface 1B of each unfired ceramic element body 11, as shown in FIG. 8D.

Next, as shown in FIG. 9E, the mother unfired ceramic element body 60 is cut into individual unfired ceramic element bodies 11.

Next, the unfired ceramic element body 11 is fired with a predetermined profile to produce the ceramic element body 1 shown in FIG. 9F.

Next, as illustrated in FIG. 9G, a jig 80 is prepared. Then, the second main surface 1B of the ceramic element body 1 is fixed to the upper main surface of the jig 80. Subsequently, for example, sandblasting is performed to cut down the ridge line E11 in which the first main surface 1A and the first end surface 1C are in contact with each other, the ridge line E12 in which the first main surface 1A and the first lateral surface 1E are in contact with each other, the ridge line E13 in which the first main surface 1A and the second end surface 1D are in contact with each other, and the ridge line E14 in which the first main surface 1A and the second lateral surface 1F are in contact with each other, respectively, to increase the R dimensions thereof.

Next, as shown in FIG. 9H, as a base external electrode of each of the first external electrode 25 and the second external electrode 26, for example, the NiCr thin film layer 27 is formed by sputtering.

Next, as shown in FIG. 9I, a predetermined catalyst is applied as necessary to the outside of the NiCr thin film layer 27, which is the base external electrode of each of the first external electrode 25 and the second external electrode 26, and then electroless plating is performed to form, for example, the Ni-plated external electrode layer 28.

Next, as shown in FIG. 9J, after a predetermined catalyst is applied to the outside of the Ni-plated external electrode layer 28 as necessary, for example, electroless plating is performed to form the Au-plated external electrode layer 29. Thus, the first external electrode 25 is formed in the L-shape on the first end surface 1C and the first main surface 1A of the ceramic element body 1, and the second external electrode 26 is formed in the L-shape on the second end surface 1D and the first main surface 1A of the ceramic element body 1, such that the multilayer ceramic capacitor 200 according to the second example embodiment is completed.

The multilayer ceramic capacitors 100 and 200 according to the example embodiments have been described above. However, the present invention is not limited to the above-described contents, and various modifications can be made in accordance with the spirit of the present invention.

For example, the above example embodiments include the step of increasing the R dimension of each of the ridge line E11 where the first main surface 1A and the first end surface 1C are in contact with each other, the ridge line E12 where the first main surface 1A and the first lateral surface 1E are in contact with each other, the ridge line E13 where the first main surface 1A and the second end surface 1D are in contact with each other, and the ridge line E14 where the first main surface 1A and the second lateral surface 1F are in contact with each other, but do not include the step of increasing the R dimension of each of the ridge line E21 where the second main surface 1B and the first end surface 1C are in contact with each other, the ridge line E22 where the second main surface 1B and the first lateral surface 1E are in contact with each other, the ridge line E23 where the second main surface 1B and the second end surface 1D are in contact with each other, and the ridge line E24 where the second main surface 1B and the second lateral surface 1F are in contact with each other. However, by adding the step of increasing the R dimension of each of the ridge line E21 in which the second main surface 1B and the first end surface 1C are in contact with each other, the ridge line E22 in which the second main surface 1B and the first lateral surface 1E are in contact with each other, the ridge line E23 in which the second main surface 1B and the second end surface 1D are in contact with each other, and the ridge line E24 in which the second main surface 1B and the second lateral surface 1F are in contact with each other, and by adjusting the degree of increasing the R dimensions between these two steps, the R dimension of each of the ridge line E11 in which the first main surface 1A and the first end surface 1C are in contact with each other, the ridge line E12 in which the first main surface 1A and the first lateral surface 1E are in contact with each other, the ridge line E13 where the first main surface 1A and the second end surface 1D are in contact with each other, and the ridge line E14 where the first main surface 1A and the second lateral surface 1F are in contact with each other may be larger than the ridge line E21 in which the second main surface 1B and the first end surface 1C are in contact with each other, the ridge line E22 where the second main surface 1B and the first lateral surface 1E are in contact with each other, the ridge line E23 where the second main surface 1B and the second end surface 1D are in contact with each other, and the ridge line E24 where the second main surface 1B and the second lateral surface 1F are in contact with each other.

Although the plurality of embossed holes 10 are preferably provided in the second main surface 1B of the ceramic element body 1 in the above example embodiment, the plurality of embossed holes 10 are not mandatory components and may be omitted in the multilayer ceramic capacitor of the present invention.

A multilayer ceramic capacitor according to one example embodiment of the present invention is as described in the section of Summary of the Invention.

In the multilayer ceramic capacitor, it is also preferable that the R dimension of each of the ridge line where the first main surface and the first end surface are in contact with each other, the ridge line where the first main surface and the first lateral surface are in contact with each other, the ridge line where the first main surface and the second end surface are in contact with each other, and the ridge line where the first main surface and the second lateral surface are in contact with each other is, for example, about 1 μm or more and about 10 μm or less. If the thickness is less than about 1 μm, the advantageous effect of reducing or preventing the occurrence of cracks, etc., in the ceramic element body when these ridge lines collide with the substrate, etc., is small. On the other hand, when the thickness exceeds about 10 μm, it takes time to increase each R dimension of these ridge lines, and the productivity of the multilayer ceramic capacitor decreases.

It is also preferable that R dimensions of a corner where the first main surface, the first end surface, and the first lateral surface are in contact with one another, a corner where the first main surface, the first lateral surface, and the second end surface are in contact with one another, a corner where the first main surface, the second end surface, and the second lateral surface are in contact with one another, and a corner where the first main surface, the second lateral surface, and the first end surface are in contact with one another are respectively larger than R dimensions of a corner where the second main surface, the first end surface, and the first lateral surface are in contact with one another, a corner where the second main surface, the first lateral surface, and the second end surface are in contact with one another, a corner where the second main surface, the second end surface, and the second lateral surface are in contact with one another, and a corner where the second main surface, the second lateral surface, and the first end surface are in contact with one another. In this case, the R dimensions of the corner where the first main surface, the first end surface, and the first lateral surface are in contact with one another, the corner where the first main surface, the first lateral surface, and the second end surface are in contact with one another, the corner where the first main surface, the second end surface, and the second lateral surface are in contact with one another, and the corner where the first main surface, the second lateral surface, and the first end surface are in contact with one another are respectively large. Therefore, when the multilayer ceramic capacitor is placed on a substrate, etc., for mounting, even if these corners collide with the substrate or an electrode provided on the substrate, the impact is mitigated, such that occurrence of cracks, etc., in the ceramic element body is reduced or prevented.

It is also preferable that the second main surface of the ceramic element body includes a plurality of embossed holes. In this case, for example, when the second main surface is suctioned by the nozzle of the mounter apparatus, even if an impact is applied by the nozzle, the ceramic element body is resistant to the impact, and occurrence of cracks, etc., in the ceramic element body is reduced or prevented.

It is also preferable that the first external electrode and the second external electrode each include, for example, a base external electrode, and at least one plated external electrode layer provided outside the base external electrode. In this case, the base external electrode may be set as a base, and the plated external electrode layer may be easily formed on the outside of the base external electrode by, for example, electroless plating.

It is also preferable that the base external electrode includes, for example, a dummy internal electrode that is shorter than the plurality of first internal electrodes and the plurality of second internal electrodes in the length direction and is exposed at the first main surface of the ceramic element body. In this case, the first external electrode and the second external electrode each having relatively large area on the first main surface of the ceramic element body can be easily formed.

It is also preferable that the dummy internal electrode is made of the same material as materials of the plurality of first internal electrodes and the second external electrode. In this case, it is not necessary to separately prepare a material for forming the dummy internal electrodes defining and functioning as the base external electrode, such that the productivity of the multilayer ceramic capacitor is improved.

It is also preferable that the dummy internal electrode includes, for example, Ni as a main component. In this case, the ceramic element body, the first internal electrodes, the second external electrodes, and the dummy internal electrodes can be easily manufactured by so-called simultaneous firing.

It is also preferable that the base external electrode is, for example, a thin film. In this case, the base external electrode can be easily formed by sputtering, for example.

In this case, the thin film includes, for example, NiCr as a main component. In this case, the adhesion to the ceramic element body is high, such that the thin film is an excellent base external electrode for the first external electrode and the second external electrode.

It is also preferable that the plated external electrode layer includes, for example, at least one selected from a Cu-plated external electrode layer, a Ni-plated external electrode layer, and an Au-plated external electrode layer. In this case, various functions are exhibited in each plated external electrode layer, and an excellent first external electrode and an excellent second external electrode can be formed.

It is also preferable that the plated external electrode layer includes, for example, the Ni-plated external electrode layer provided outside the base external electrode and the Au-plated external electrode layer provided outside the Ni-plated external electrode layer. In this case, the Ni-plated external electrode layer can mainly function to improve solder heat resistance and bonding properties, and the Au-plated external electrode layer 9 can mainly function to improve the wettability of the external electrode layer to solder.

It is also preferable that the plated external electrode layer includes, for example, the Cu-plated external electrode layer provided outside the base external electrode, the Ni-plated external electrode layer provided outside the Cu-plated external electrode layer, and the Au-plated external electrode layer provided outside the Ni-plated external electrode layer. In this case, the Cu-plated external electrode layer 7 can mainly define and function to improve moisture: resistance, the Ni-plated external electrode layer can mainly function to improve solder heat resistance and bonding properties, and the Au-plated external electrode layer 9 can define and function to improve wettability of the external electrode layer to solder.

It is also preferred that the Ni-plated external electrode layer includes, for example, P. In this case, the mechanical strength of the external electrode layer is improved.

It is also preferred that the Cu-plated external electrode layer includes, for example, Ni. In this case, dissolution of the external electrode layer into the solder can be reduced or prevented.

It is also preferable that one of a dimension in the length direction or a dimension in the width direction W is, for example, about 1.0 mm or less and the other is about 0.5 mm or less. It is also preferable that the dimension in the height direction is, for example, about 0.1 mm or less. Even when the present invention is applied to a multilayer ceramic capacitor that is reduced in size and has thin layers as described above, since the R dimensions of the ridge line where the first main surface, which is the mounting surface, and the first end surface are in contact with each other, the ridge line where the first main surface and the first lateral surface are in contact with each other, the ridge line where the first main surface and the second end surface are in contact with each other, and the ridge line where the first main surface and the second lateral surface are in contact with each other are large, even if these ridge lines collide with a substrate or an electrode formed on the substrate, etc., at the time of mounting, the occurrence of cracks, etc., in the ceramic element body is reduced or prevented.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a ceramic element body including ceramic layers, first internal electrodes and second internal electrodes laminated in a height direction, a first main surface and a second main surface opposed to each other in the height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction; and
a first external electrode and a second external electrode on an outer surface of the ceramic element body; wherein
each of the first internal electrodes extends toward and is exposed at the first end surface, and is electrically connected with the first external electrode;
each of the plurality of second internal electrodes extends toward and is exposed at the second end surface, and is electrically connected with the second external electrode;
when a cross section parallel or substantially parallel to the first lateral surface and the second lateral surface is viewed, the first external electrode has an L-shape on the first end surface and the first main surface, and the second external electrode has an L-shape on the second end surface and the first main surface; and
R dimensions of a ridge line where the first main surface and the first end surface are in contact with each other, a ridge line where the first main surface and the first lateral surface are in contact with each other, a ridge line where the first main surface and the second end surface are in contact with each other, and a ridge line where the first main surface and the second lateral surface are in contact with each other are respectively larger than R dimensions of a ridge line where the second main surface and the first end surface are in contact with each other, a ridge line where the second main surface and the first lateral surface are in contact with each other, a ridge line where the second main surface and the second end surface are in contact with each other, and a ridge line where the second main surface and the second lateral surface are in contact with each other.

2. The multilayer ceramic capacitor according to claim 1, wherein the R dimension of each of the ridge line where the first main surface and the first end surface are in contact with each other, the ridge line where the first main surface and the first lateral surface are in contact with each other, the ridge line where the first main surface and the second end surface are in contact with each other, and the ridge line where the first main surface and the second lateral surface are in contact with each other is about 1 μm or more and about 10 μm or less.

3. The multilayer ceramic capacitor according to claim 1, wherein R dimensions of a corner where the first main surface, the first end surface, and the first lateral surface are in contact with one another, a corner where the first main surface, the first lateral surface, and the second end surface are in contact with one another, a corner where the first main surface, the second end surface, and the second lateral surface are in contact with one another, and a corner where the first main surface, the second lateral surface, and the first end surface are in contact with one another are respectively larger than R dimensions of a corner where the second main surface, the first end surface, and the first lateral surface are in contact with one another, a corner where the second main surface, the first lateral surface, and the second end surface are in contact with one another, a corner where the second main surface, the second end surface, and the second lateral surface are in contact with one another, and a corner where the second main surface, the second lateral surface, and the first end surface are in contact with one another.

4. The multilayer ceramic capacitor according to claim 1, wherein the second main surface includes a plurality of embossed holes.

5. The multilayer ceramic capacitor according to claim 1, wherein
the first external electrode and the second external electrode each include:
a base external electrode; and
at least one plated external electrode layer provided outside the base external electrode.

6. The multilayer ceramic capacitor according to claim 5, wherein the base external electrode includes a dummy internal electrode that is shorter than the first internal electrodes and the second internal electrodes in the length direction and is exposed at the first main surface of the ceramic element body.

7. The multilayer ceramic capacitor according to claim 6, wherein the dummy internal electrode is made of a same material as materials of the first internal electrodes and the second external electrode.

8. The multilayer ceramic capacitor according to claim 6, wherein the dummy internal electrode includes Ni as a main component.

9. The multilayer ceramic capacitor according to claim 5, wherein the base external electrode is a thin film.

10. The multilayer ceramic capacitor according to claim 9, wherein the thin film includes NiCr as a main component.

11. The multilayer ceramic capacitor according to claim 5, wherein the plated external electrode layer includes at least one selected from a Cu-plated external electrode layer, a Ni-plated external electrode layer, and an Au-plated external electrode layer.

12. The multilayer ceramic capacitor according to claim 11, wherein the plated external electrode layer includes the Ni-plated external electrode layer provided outside the base external electrode and the Au-plated external electrode layer provided outside the Ni-plated external electrode layer.

13. The multilayer ceramic capacitor according to claim 11, wherein the plated external electrode layer includes the Cu-plated external electrode layer provided outside the base external electrode, the Ni-plated external electrode layer provided outside the Cu-plated external electrode layer, and the Au-plated external electrode layer provided outside the Ni-plated external electrode layer.

14. The multilayer ceramic capacitor according to claim 11, wherein the Ni-plated external electrode layer includes P.

15. The multilayer ceramic capacitor according to claim 11, wherein the Cu-plated external electrode layer includes Ni.

16. The multilayer ceramic capacitor according to claim 1, wherein one of a dimension in the length direction or a dimension in the width direction W is about 1.0 mm or less and the other is about 0.5 mm or less.

17. The multilayer ceramic capacitor according to claim 1, wherein a dimension in the height direction is about 0.1 mm or less.

18. The multilayer ceramic capacitor according to claim 1, wherein a thickness of each of the ceramic layers is about 0.3 μm to about 2.0 μm.

19. The multilayer ceramic capacitor according to claim 4, wherein the embossed holes are recessed holes including a bottom.
